(19) United States
(12) Patent Application Publication
(10) Pub. No.: US 2008/0199698 A1
(43) Pub. Date: Aug. 21, 2008

(54) Method for producing liquid crystalline polyester fiber

(75) Inventors: Yusaku Kohinata, Tsukuba-shi (JP); Satoshi Okamoto, Tsukuba-shi (JP)

Correspondence Address: FOLEY AND LARDNER LLP;SUITE 500, 3000 K STREET NW, WASHINGTON, DC, 20007, US

(73) Assignee: SUMITOMO CHEMICAL COMPANY, LIMITED

(21) Appl. No.: 11/907,441

(22) Filed: Oct. 12, 2007

(30) Foreign Application Priority Data
Feb. 16, 2007 (JP) 2007-036775

(51) Int. Cl. D02G 3/00; B29C 47/00

(52) U.S. Cl. 428/401; 264/465

(57) ABSTRACT

The present invention provides a method for producing a liquid crystalline polyester fiber, the method comprising the steps of discharging an electrically charged solution comprising a liquid crystalline polyester, a fiber-forming polymer and a solvent from a container; and drawing the charged solution by electrical attraction in an electrical field generated between the solution and an electrically charged collecting means having the opposite charge of the solution, while evaporating at least a portion of the solvent to form a liquid crystalline polyester fiber. The fiber obtained in the present invention has a small average fiber diameter and can be made into a thin fiber cloth with high density.

### BACKGROUND OF THE INVENTION

1. Field of the Invention

The present invention relates to a liquid crystalline polyester fiber, a liquid crystalline polyester fiber cloth and a method for producing a liquid crystalline polyester fiber.

2. Description of the Related Art

A glass fiber cloth has frequently been used as a base material for a printed wiring board for a long time. However, because of disadvantages (such as high dielectric constant and heavy weight) which the glass fiber has, a material which can be used as a base material instead of the glass fiber has been requested in recent years. For example, a liquid crystal aramid fiber has been studied for application to the base material by reason of having fewer disadvantages like those of the glass fiber. However, the aramid fiber has not yet been sufficient for the base material for a printed wiring board, in which excellent electrical insulating properties are required, because the aramid fiber may have high hygroscopicity.

A liquid crystalline polyester has been expected as the base material for a printed wiring board because of its properties such as high heat resistance, low dielectric constant and low hygroscopicity. For example, a printed wiring board having a woven cloth of a molten liquid crystalline polyester fiber as the base material is disclosed (see, Japanese Unexamined Patent Publication No. 62-36892). Also, a base material (fiber cloth) for a printed wiring board made of molten liquid crystalline polyester having an average fiber diameter of 1 to 15 μm is disclosed (see, Japanese Unexamined Patent Publication No. 2002-64254). It is disclosed that the former molten liquid crystalline polyester fiber is obtained by melt spinning, and that the latter fiber cloth is obtained by a meltblown method.

The above-mentioned conventional woven cloth and liquid crystalline polyester fiber cloth may be low in fiber density with a large average fiber diameter and tends to have difficulty in being in the a thin form, while the printed wiring board has been requested to be thin in order to downsize an electronic equipment mounted therewith in recent years.

### SUMMARY OF THE INVENTION

The present invention has been made under such circumstances. One of objects of the present invention is to provide for a liquid crystalline polyester fiber which can be made into a sufficiently thin cloth, sheet or the like of the fiber.

In order to achieve the above-mentioned object and other objects, the present inventors have studied on providing for a thinner liquid crystalline polyester fiber which can be made into a fiber cloth with low density. As a result, the present inventors have found a method for producing a very thin fiber (typically having an average diameter of 0.01 to 1 μm) comprising liquid crystalline polyester, and a method for producing a very thin fiber cloth of the liquid crystalline polyester fiber, and have accomplished the present invention.

The present invention provides a method for producing a liquid crystalline polyester fiber, the method comprising the steps of:

discharging an electrically charged solution comprising a liquid crystalline polyester, a fiber-forming polymer and a solvent from a container; and

drawing the charged solution by electrical attraction in an electrical field generated between the solution and an electrically charged collecting means having the opposite charge of the solution, while evaporating at least a portion of the solvent to form a liquid crystalline polyester fiber.

In the present invention, a liquid crystalline polyester fiber is produced by a so-called electrostatic spinning, wherein a polymer solution comprising a liquid crystalline polyester is discharged in an electric field to be scatted by electrical attraction. The inventors of the present invention have found that a thinner liquid crystalline polyester fiber can be formed by the production method of the present invention, as compared to the liquid crystalline polyester fibers obtained by physical forces in the conventional methods such as a melt spinning and a meltblown method. The liquid crystalline polyester fiber obtained in the present invention can be thin and fine, since the electrostatic spinning in the present invention allows the liquid crystalline polyester solution to be drawn out by electrical attraction so as to form a thin, fine fiber. The liquid crystalline polyester fiber obtained by the production method of the present invention can be made into a higher density cloth, which results in providing for a sufficiently thin fiber cloth of the liquid crystalline polyester.

### BRIEF DESCRIPTION OF THE DRAWINGS

FIG. 1 is a view showing an example electrostatic spinning apparatus which can be utilized in the present invention;

FIG. 2 is a view showing a SEM photograph of the surface of a fiber substance obtained in Example 1;

FIG. 3 is a view showing a SEM photograph on the surface of a fiber substance obtained in Example 2; and

FIG. 4 is a view showing a SEM photograph on the surface of a substance obtained in Comparative Example 1.

### DETAILED DESCRIPTION OF THE PREFERRED EMBODIMENTS

In the present invention, a liquid crystalline polyester fiber can be produced by a method comprising the steps of:

discharging an electrically charged solution comprising a liquid crystalline polyester, a fiber-forming polymer and a solvent from a container; and

drawing the charged solution by electrical attraction in an electrical field generated between the solution and an electrically charged collecting means (such as sheet) having the opposite charge of the solution, while evaporating at least a portion of the solvent to form a liquid crystalline polyester fiber.

The liquid crystalline polyester to be used in the present invention is preferably a thermotropic liquid crystal polymer exhibiting liquid crystallinity in a molten state, which may express a melt exhibiting optical anisotropy at a temperature of 450° C. or lower.

The liquid crystalline polyester is preferably soluble in an organic solvent. Such a liquid crystalline polyester is advantageous in preparing a thin liquid crystalline polyester fiber in the present invention, since the liquid crystalline polyester is capable of easily producing a polymer solution comprising the liquid crystalline polyester which can be easily applied in the electrostatic spinning mentioned above.

From the viewpoint of heat resistance of the resulting fiber, the liquid crystalline polyester is more preferably an aromatic liquid crystalline polyester capable of forming a structure called an I type. Examples of the aromatic liquid crystalline polyester include those having structural units derived from aromatic hydroxycarboxylic acid, aromatic diol, aromatic diamine, aromatic amine having a hydroxyl group and/or aromatic dicarboxylic acid.

More specifically, the liquid crystalline polyester is preferably an aromatic liquid crystalline polyester which has structural units represented by the following formulae (1), (2) and (3) in appropriate combinations thereof.

—O—Ar¹—CO— (1)

—X—Ar²—Y— (2)

—OC—Ar³—CO— (3)

Here, the structural unit represented by the formula (1) is derived from aromatic hydroxycarboxylic acid, the structural unit represented by the formula (2) is derived from aromatic diol, aromatic diamine or aromatic amine substituted with a hydroxyl group in an aromatic ring, and a structural unit represented by the formula (3) is derived from aromatic dicarboxylic acid.

In the formulae (1), (2) and (3), Ar¹ denotes at least one moiety selected from the group consisting of 1,4-phenylene, 2,6-naphthylene and 4,4′-biphenylene; Ar² denotes at least one moiety selected from the group consisting of 1,4-phenylene, 1,3-phenylene and 4,4′-biphenylene; Ar³ denotes at least one moiety selected from the group consisting of 1,4-phenylene group, 1,3-phenylene group, 2,6-naphthylene group and a group represented by the following formula (4), and X and Y denote, each independently, —O— or —NH—.

Ar⁴¹-Z-Ar⁴²— (4)

In the formula (4), Ar⁴¹ and Ar⁴² denote, each independently, at least one moiety selected from the group consisting of 2,6-naphthylene and 4,4′-biphenylene, and Z denotes at least one moiety selected from the group consisting of —O—, —SO₂— and —CO—.

The aromatic liquid crystalline polyester having the above-mentioned units is preferably applied to electrostatic spinning, since the polyester is soluble in an organic solvent to easily prepare a polymer solution comprising the polyester, and is appropriate to prepare a liquid crystalline polyester fiber having a thin fiber diameter. The fiber obtained in the present invention using the liquid crystalline polyester having the above-mentioned units can have high heat resistance, low dielectric constant and low hygroscopicity, even in the case where the fiber has a thin fiber diameter.

From the viewpoint of liquid crystallinity, the aromatic liquid crystalline polyester preferably has at least structural units of the above-mentioned formulae (1), (2) and (3). The aromatic liquid crystalline polyester preferably has 30 to 80% by mol of the formula (1), 10 to 35% by mol of the formula (2) and 10 to 35% by mol of the formula (3) on the basis of the total amount of the structural units of the formulae (1), (2) and (3). Such an aromatic liquid crystalline polyester has an excellent liquid crystallinity and a sufficient solubility in an aprotic solvent described below as an appropriate organic solvent, which provides for a preferred polymer solution.

The structural units of the above-mentioned formulae (1), (2) and (3) in the aromatic liquid crystalline polyester may be obtained using the above-mentioned compounds as raw material compounds. Thus, the aromatic liquid crystalline polyester can be prepared by condensing the compounds corresponding to the structural units by a known method.

The raw material compounds may be the derivatives thereof corresponding to the structural units of the formulae (1), (2) and (3), which is preferred for the condensation. For example, instead of using the aromatic hydroxycarboxylic acid and the aromatic dicarboxylic acid, it is possible to use the acid chlorides and acid anhydride of the acids, which is preferred as the raw material compounds in the reaction for preparing polyester. Alternatively, the acids as the raw material compounds may be the derivatives thereof which have carboxyl groups in the form of ester with alcohols and carboxylic acids so as to easily prepare polyester by transesterification reaction during condensation.

In addition, instead of using the aromatic diol and the aromatic amine having a hydroxyl group in its aromatic ring, it is possible to use as the raw material compounds the derivatives thereof which have phenolic hydroxyl groups in the form of ester with carboxylic acids so as to easily prepare polyester by transesterification reaction. Further, instead of using the aromatic diamine and aromatic amine having a hydroxyl group in its aromatic ring, it is possible to use as the raw material compounds the derivatives thereof which have amino groups in the form of amide with carboxylic acids so as to easily prepare polyamide by amide interchange reaction.

Preferable examples of the raw material compounds for a structural unit represented by the above-mentioned formula (1) include p-hydroxybenzoic acid, 2-hydroxy-6-naphthoic acid, 4-hydroxy-4′-biphenylcarboxylic acid or derivatives thereof. Among them, 2-hydroxy-6-naphthoic acid is more preferred. In the aromatic liquid crystalline polyester, two or more kinds of structural unit represented by the formula (1), which may be derived from the raw material compounds as described above, may be included.

The aromatic liquid crystalline polyester preferably has the structural unit represented by the formula (1) in the amount of 30 to 80% by mol, more preferably in the amount of 35 to 65% by mol and most preferably in the amount of 40 to 55% by mol on the basis of the total of structural units represented by the formulae (1) to (3). When the structural unit represented by the formula (1) is contained in the above-mentioned range, solubility of the aromatic liquid crystalline polyester in a solvent tends to be so high as to prepare a preferable polymer solution for electrostatic spinning and to obtain good liquid crystallinity.

Preferable examples of the raw material compounds for a structural unit represented by the above-mentioned formula (2) include resorcin, hydroquinone, 3-aminophenol, 4-aminophenol, 1,4-phenylenediamine, 1,3-phenylenediamine, 4,4′-diaminodiphenyl ether, 4-hydroxy-4′-biphenyl alcohol or derivatives thereof. Among them, 4-aminophenol is more preferred. In the aromatic liquid crystalline polyester, two or more kinds of structural unit represented by the formula (2), which may be derived from the raw material compounds as described above, may be included.

The aromatic liquid crystalline polyester preferably has the structural unit represented by the formula (2) in the amount of 10 to 35% by mol, more preferably in the amount of 17.5 to 32.5% by mol and most preferably in the amount of 22.5 to 30% by mol on the basis of the total of structural units represented by the formulae (1) to (3). When the structural unit represented by the formula (2) is contained in the above-mentioned range, solubility of the aromatic liquid crystalline polyester in a solvent tends to be so high as to prepare a preferable polymer solution for electrostatic spinning and to obtain good liquid crystallinity.

Preferable examples of the raw material compounds for a structural unit represented by the above-mentioned formula (3) include terephthalic acid, isophthalic acid, 2,6-naphthalene dicarboxylic acid, diphenyl ether-4,4′-dicarboxylic acid, diphenyl sulfone-4,4′-dicarboxylic acid, benzophenone-4,4′-dicarboxylic acid or derivatives thereof. Among them, a compound capable of providing the resulting aromatic liquid crystalline polyester with high flexibility is more preferred, since the aromatic liquid crystalline polyester with high flexibility tends to have high solubility in a solvent. Examples of such a preferred compound include isophthalic acid and a compound from which a structural unit represented by the above-mentioned formula (4) can be derived. Among them, isophthalic acid is particularly preferred. In the aromatic liquid crystalline polyester, two or more kinds of structural unit represented by the formula (3), which may be derived from the raw material compounds as described above, may be included.

The aromatic liquid crystalline polyester preferably has the structural unit represented by the formula (3) in the amount of 10 to 35% by mol, more preferably in the amount of 17.5 to 32.5% by mol and most more preferably in the amount of 22.5 to 30% by mol on the basis of the total of structural units represented by the formulae (1) to (3).

In the aromatic liquid crystalline polyester, structural units represented by the formula (2) and structural units represented by the formula (3) are preferably contained so that the molar ratio (% by mol) of the structural units represented by the formula (2) to the structural units represented by the formula (3) is within the range of from 0.85 to 1.25, and is more preferably approximately 1. When the structural units represented by the formula (2) and the structural units represented by the formula (3) are contained in an approximately equal amount, the resulting aromatic liquid crystalline polyester tends to have preferable degree of polymerization.

The aromatic liquid crystalline polyester may be obtained by polymerizing the above-mentioned raw material compounds by such known methods as described in Japanese Unexamined Patent Publications No. 2002-220444 and No. 2002-146003.

For example, in order to obtain the aromatic liquid crystalline polyester, first, an aromatic hydroxycarboxylic acid (which is the raw material compound corresponding to the structural unit represented by the formula (1)) and an aromatic diol, an aromatic diamine or an aromatic amine having a hydroxyl group in its aromatic ring (which is the raw material compound corresponding to the structural unit represented by the formula (2)) are reacted with a fatty acid anhydride so as to acylate the phenolic hydroxyl group and amino group in the raw material compounds (acylation reaction). In this reaction, the fatty acid anhydride is preferable used in the molar amount lager than the molar amount of the phenolic hydroxyl group and the amino group. Subsequently, the obtained acylated compounds and the aromatic dicarboxylic acid as the raw material compound corresponding to the structural unit represented by the formula (3) are reacted by melt polymerization to obtain an aromatic liquid crystalline polyester. The polymerization reaction is a polycondensation reaction which is promoted principally by a transesterification and/or an amide interchange reaction between the acylated compound and the aromatic dicarboxylic acid.

In the above-mentioned acylation reaction, the fatty acid anhydride is preferably used in the amount of from 1 to 1.2 times of equivalent, more preferably in the amount of from 1.05 to 1.1 times of equivalent, with respect to the total amount of the phenolic hydroxyl group and amino group to be reacted therewith. In such a manner, in the subsequent transesterification reaction and amide interchange reaction, the acylated compounds as well as the raw material compounds tend to be difficult to sublime, which results in suppressing the problem such that the reaction system is blockaded, thereby decreasing coloration of the resulting liquid crystalline polyester. The acylation reaction is preferably performed at a temperature of from 130 to 180° C. for 5 minutes to 10 hours, and is more preferably at a temperature of from 140 to 160° C. for 10 minutes to 3 hours.

The fatty acid anhydride for the acylation reaction is not particularly limited. Examples of the fatty acid include acetic anhydride, propionic anhydride, butyric anhydride, isobutyric anhydride, valeric anhydride, pivalic anhydride, 2-ethyl hexoic anhydride, monochloroacetic anhydride, dichloroacetic anhydride, trichloroacetic anhydride, monobromoacetic anhydride, dibromoacetic anhydride, tribromoacetic anhydride, monofluoroacetic anhydride, difluoroacetic anhydride, trifluoroacetic anhydride, glutaric anhydride, maleic anhydride, succinic anhydride and β-bromopropionic anhydride. These may be used in a combination of two kinds or more thereof. Among them, acetic anhydride, propionic anhydride, butyric anhydride and isobutyric anhydride are preferable, and acetic anhydride is more preferable. These are easy to hand and are easily available at an inexpensive price.

The transesterification reaction and amide interchange reaction are preferably performed using the aromatic dicarboxylic acid and the acylated compounds so that the molar amount of the carboxyl group in the aromatic dicarboxylic acid is 0.8 to 1.2 times of equivalent with respect to the acyl group in the acylated compounds. The transesterification reaction and amide interchange reaction are preferably performed while heating up to 400° C. at a rate of 0.1 to 50° C./minute, more preferably up to 350° C. at a rate of 0.3 to 5° C./minute. Under such conditions, the aromatic liquid crystalline polyester tends to be efficiently prepared as a reaction product. In the transesterification reaction and amide interchange reaction, in order to shift equilibrium of the reactions to the side of the product, the reactions are preferably performed while removing the fatty acid as by-products in the reactions and the unreacted fatty acid anhydride out of the reaction system by vaporizing.

The above-mentioned acylation reaction, transesterification and amide interchange reaction may be performed in the presence of catalyst. A known catalyst for polymerizing polyester can be utilized as the catalyst in those reactions. Examples of the catalyst include metallic salt catalysts such as magnesium acetate, stannous acetate, tetrabutyl titanate, lead acetate, sodium acetate, potassium acetate and antimony trioxide, and organic compound catalysts such as N,N-dimethylaminopyridine and N-methylimidazole.

Among them, heterocyclic compounds containing two or more of nitrogen atoms (such as N,N-dimethylaminopyridine and N-methylimidazole) are preferred. The catalysts may be added to the reaction mixture before conducting the acylation reaction and subsequently may be left in the reaction mixture during the transesterification reaction without being removed after the acylation reaction.

The polycondensation conducted in the transesterification reaction and amide interchange reaction may be preferably carried out by melt polymerization as described above. The melt polymerization may be followed by a solid phase polymerization. The solid phase polymerization may be performed in such a manner that the polymer obtained after the melt polymerization is taken out of the melt polymerization reaction mixture and is ground (crushed) into the powders or flakes thereof, which are then subjected to the solid phase polymerization. The solid phase polymerization is preferably performed by heat-treating the polymer obtained after the melt polymerization in a solid state under an inert atmosphere such as nitrogen at a temperature of from 20 to 350° C. for 1 to 30 hours. Also, the solid phase polymerization may be performed while stirring or in a still standing state.

The melt polymerization and solid phase polymerization may be performed in the same reaction vessel installed with an appropriate stirring mechanism. The aromatic liquid crystalline polyester obtained after the solid phase polymerization may be pelletized by a known method, which may be followed by molding. The above-mentioned methods for producing the aromatic liquid crystalline polyester can be performed batch-wise, or using a device for continuous reactions.

In the present invention, a liquid crystalline polyester fiber may be produced in an electrostatic spinning method in which a solution containing raw materials for the fiber is scattered in an electric field by electrical attraction. Specifically, a liquid crystalline polyester fiber may be produced by the method which comprises the steps of:

discharging an electrically charged solution comprising a liquid crystalline polyester, a fiber-forming polymer and a solvent from a container; and

drawing the charged solution by electrical attraction in an electrical field generated between the solution and an electrically charged collecting means having the opposite charge of the solution, while evaporating at least a portion of the solvent to form a liquid crystalline polyester fiber.

One of example methods for producing the liquid crystalline polyester fiber is as follows:

A pair of electrodes are oppositely disposed and impressed with voltage to cause an electrostatic field. In this state, the solution containing raw materials for fiber is disposed on one electrode side (typically, positive electrode), and the solution thus charged is scattered toward the other electrode side (typically, negative electrode) in an electrostatic field by electrical attraction. At that time, the solution is widely dispersed, and the raw materials for fiber contained in the solution are extended and transformed into the fiber thereof by attraction force from the other electrode side. The fiber thus formed is collected by a collection substrate disposed on the opposite electrode side, to consequently obtain a fiber substance.

In the present invention, a liquid crystalline polyester fiber with an average fiber diameter of 0.01 to 1 μm can be obtained. The liquid crystalline polyester fiber obtained in the present invention has a thinner fiber diameter as compared to conventionally obtained liquid crystalline polyester fibers, and therefore, can provide for a liquid crystalline polyester fiber cloth which is sufficiently thin and has a higher density. Such a liquid crystalline polyester fiber cloth is preferably utilized for a printed wiring board mounted on small-sized electronic parts.

The production method of the liquid crystalline polyester fiber may be conducted using an apparatus comprising a container in which a solution of the liquid crystalline polyester as a raw material is supplied, and a collecting means on which the resulting liquid crystalline polyester fiber is collected.

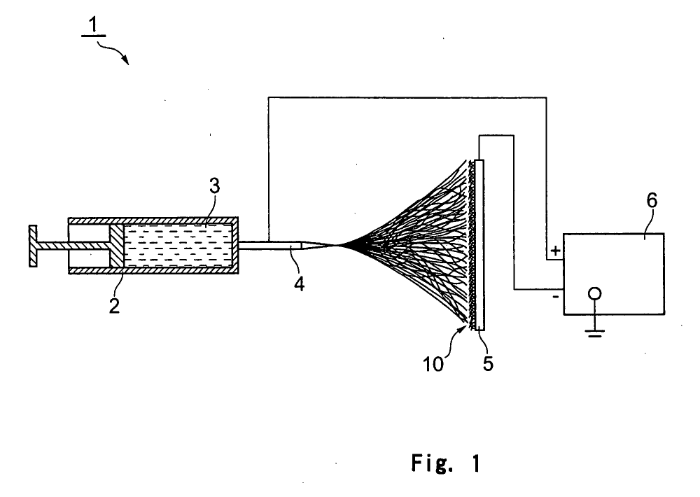

FIG. 1 is a view showing an example electrostatic spinning apparatus which can be used as a device for producing a liquid crystalline polyester fiber of the present invention.

As shown in FIG. 1, an electrostatic spinning apparatus 1 is composed of a syringe 2 for accommodating a solution (polymer solution 3) containing at least a liquid crystalline polyester as a raw material, a nozzle 4 for discharging the polymer solution, which is provided at the tip end of this syringe 2, a collecting means (collection electrode 5) to which a liquid crystalline polyester fiber formed by electrostatic spinning is attached, and a voltage generator 6 connected to the nozzle 4 and the collection electrode 5 to impress these with voltage. In this electrostatic spinning apparatus 1, the nozzle 4 functions as the above-mentioned one electrode, and the collection electrode 5 serves both as the above-mentioned other electrode and collection substrate.

In the electrostatic spinning apparatus 1, the nozzle 4 is made of electrically-conductive materials of metal and the like for functioning as the electrode. Similarly, the collection electrode 5 is made of electrically-conductive materials and may have a composition such that an insulative substrate is coated with electrically-conductive materials. The syringe 2 is a vessel capable of internally accommodating the polymer solution 3. The voltage generator 6 is connected to the syringe 2 and the collection substrate 5, between which voltage can be impressed.

In a method for producing a liquid crystalline polyester fiber by using the electrostatic spinning apparatus 1, a solution (polymer solution 3) comprising a liquid crystalline polyester, a fiber-forming polymer and a solvent may be utilized. In the polymer solution 3, a liquid crystalline polyester and a fiber-forming polymer are preferably dissolved in a solvent.

The fiber-forming polymer used in the present invention may be a polymer having a molecular chain with high flexibility and having properties exhibiting high association in the polymer solution applied to an electrostatic spinning. The fiber-forming polymer can promote fiber-formation of liquid crystalline polyester in an electrostatic spinning due to such properties thereof. Preferable examples of the fiber-forming polymer include a thermoplastic polymer such as polyalkylene oxide and vinyl resin. Preferably, the fiber-forming polymer is a polymer which can be easily removed by washing with a solvent such as water after the electrostatic spinning. In view of solubility, preferable examples of the fiber-forming polymer include polyethylene oxide (polyethylene glycol), polypropylene oxide, polyvinyl alcohol, polyvinyl alkyl ester (of which alkyl group is preferably an alkyl group having 1 to 6 carbon atoms), polyvinyl alkyl ether (of which alkyl group is preferably an alkyl group having 1 to 6 carbon atoms), polyvinylpyridine and polyacrylamide. Among them, polyethylene oxide, polypropylene oxide and a mixture thereof can prepare a polymer solution having a viscosity suitable for the electrostatic spinning, and therefore, are preferable from the viewpoint of workability.

The fiber-forming polymer preferably has a molecular weight of 200,000 or more. The fiber-forming polymer having the molecular weight of 200,000 or more can prepare a polymer solution having a viscosity suitable for an electrostatic spinning. When the fiber-forming polymer having a molecular weight of less than 200,000, the excessive amount of the fiber-forming polymer may be needed for obtaining appropriate viscosity of the polymer solution 3, which may result in enlarging the fiber diameter of the resulting liquid crystalline polyester fiber. In such a case, the fiber-forming polymer tends to remain in the resulting liquid crystalline polyester fiber after being washed with the solvent having properties capable of dissolving the fiber-forming polymer. The remaining fiber-forming polymer may deteriorate electrical characteristics of the liquid crystalline polyester fiber and the fiber substance prepared therefrom. In order to efficiently suppress such a tendency, it is more preferred to use a fiber-forming polymer having a molecular weight of 500,000 or more. The molecular weight of the fiber-forming polymer can be measured by gel permeation chromatography (GPC) in terms of polystyrene having its standard molecular weight. The commercially available fiber-forming polymers having the above-mentioned molecular weight can be utilized in the present invention.

A solvent used in the polymer solution 3 is preferably selected from the solvents capable of dissolving the liquid crystalline polyester and the fiber-forming polymer, and further preferably selected from the solvents capable of vaporizing in the electrostatic spinning. Examples of the solvent include halogen solvents such as 1-chlorobutane, chlorobenzene, 1,1-dichloroethane, 1,2-dichloroethane and chloroform, ether solvents such as diethyl ether, tetrahydrofuran and 1,4-dioxane, ketone solvents such as acetone and cyclohexanone, ester solvents such as ethyl acetate, lactone solvents such as γ-butyrolactone, carbonate solvents such as ethylene carbonate and propylene carbonate, nitrile solvents such as acetonitrile and succinonitrile, amide solvents such as N,N′-dimethylformamide, N,N′-dimethylacetamide, tetramethylurea and N-methylpyrrolidone, nitro solvents such as nitromethane and nitrobenzene, sulfur-containing solvents such as dimethyl sulfoxide and sulfolane, and phosphorus-containing solvents such as hexamethylphosphoric amide and tri-n-butylphosphoric acid.

Among these solvents, it is preferred to use an aprotic solvent having no halogen atoms and a dipole moment of from 3 to 5. Specifically, preferable solvents include N,N-dimethylformamide, N,N-dimethylacetamide, N-methylpyrrolidone and dimethyl sulfoxide. Therefore, it is preferred to use at least one kind of solvent selected from the group consisting of N,N-dimethylacetamide, N,N-dimethylformamide, N-methylpyrrolidone and dimethyl sulfoxide. Such a solvent can favorably dissolve both of the liquid crystalline polyester and the fiber-forming polymer, particularly the above-mentioned preferred liquid crystalline polyester. Such a solvent can be used to effectively conduct the electrostatic spinning in the present invention and is environment friendly.

The above-mentioned solvent may be used alone or in combination thereof. Other solvents, in which the liquid crystalline polyester and the fiber-forming polymer are difficult to be dissolved, may be used unless the spinnability of the liquid crystalline polyester is deteriorated.

The content (concentration) of the liquid crystalline polyester in the polymer solution 3 is preferably in the range of from 3 to 30% by weight, more preferably in the range of from 5 to 25% by weight and most preferably in the range of from 5 to 20% by weight on the basis of the total amount of the polymer solution 3. When the polymer solution 3 having the content of the liquid crystalline polyester of smaller than 3% by weight is used, fiber formation may be difficult due to the low viscosity of the solution. On the other hand, the polymer solution 3 having the content of the liquid crystalline polyester of larger than 30% by weight is used, the viscosity of the polymer solution 3 may increase so much that the solution is difficult to scatter during the electrostatic spinning, which may result in that the fiber formation becomes difficult.

The content of the fiber-forming polymer is preferably lower than that of the liquid crystalline polyester. Specifically, the content (concentration) of the fiber-forming polymer is preferably in the range of from 0.01 to 0.3% by weight, and more preferably in the range of from 0.02 to 0.16% by weight on the basis of the total amount of the polymer solution 3. Too low content thereof may bring the possibility of not sufficiently attaining the effects of the fiber-forming polymer. On the other hand, too high content thereof may bring the possibility of increasing the fiber diameter of the resulting liquid crystalline polyester fiber.

In a method for producing a liquid crystalline polyester fiber of the present invention by using the electrostatic spinning apparatus 1, the polymer solution 3 is accommodated inside the syringe 2 and supplied to the nozzle 4. This syringe 2 functions so that the polymer solution 3 accommodated inside is always filled up to the tip of the nozzle 4 at least during the electrostatic spinning, but yet does not need to push out the polymer solution 3.

When the nozzle 4 and the collection electrode 5 are impressed with voltage by operating the voltage supplier 6, an electrostatic field is generated therebetween, which result in that the polymer solution 3 in the nozzle 4 is charged and is drawn by the electrical attraction generated between the polymer solution 3 and the collection electrode 5 having the opposite charge (to the charge) of the polymer solution 3. When the impressed voltage is so high voltage that a certain degree or more of the electrical attraction is generated, then the polymer solution 3 is scattered toward the side of the collection electrode 5.

The polymer solution 3 charged and scattered from the nozzle 4 is attracted to the side of the collection electrode and linearly dispersed. On this occasion, the charged solution 3 is drawn by electrical attraction in the electrical field generated between the solution and the collection electrode 5 (collecting means), while evaporating at least a portion of the solvent to form a liquid crystalline polyester fiber. The liquid crystalline polyester fiber thus formed reaches the collection substrate 5 and is collected on the substrate. The liquid crystalline polyester fiber collected on the substrate typically comprises the liquid crystalline polyester and the fiber-forming polymer. The liquid crystalline polyester fiber is typically produced so as to form a liquid crystalline polyester fiber substance (fiber substance 10) such as a fiber cloth.

In the electrostatic spinning, at least a portion of the solvent contained in the polymer solution 3 vaporizes and is removed before reaching the collection substrate 5. The electrostatic spinning may be performed under reduced pressure to remove almost all of the solvent. The fiber-forming polymer may vaporize and is removed together with the solvent, or may be contained in to the liquid crystalline polyester fiber. In the latter case, the fiber-forming polymer can be removed at the washing step mentioned below. Unless otherwise inconvenient, the solvent and the fiber-forming polymer which have not been removed away may be contained in the fiber substance 10.

The temperature of the polymer solution 3 in the electrostatic spinning is preferably 60° C. or higher, and is more preferably 80° C. or higher. The temperature in such a range allow the liquid crystalline polyester fiber and the fiber-forming polymer to be so favorably dissolved in the polymer solution 3 and to be sufficiently drawn so that the electrostatic spinning is easily performed to form a thin, fine fiber. Here, the temperature of the polymer solution 3 in the electrostatic spinning may be a temperature at which, at the lowest, the scattering of the solution from the nozzle 4 is started, and can be adjusted by maintaining the polymer solution 3 in the syringe 2 at such a temperature.

In the electrostatic spinning, in order to sufficiently scatter the polymer solution 3, the impressed voltage is preferably in the range of from 3 to 100 kV, more preferably in the range of from 5 to 50 kV and most preferably in the range of from 8 to 30 kV in the electric potential between the nozzle 4 and the collection electrode 5. The distance between the tip of the nozzle 4 and the collection electrode 5 is preferably a distance in which the polymer solution 3 is sufficiently scattered at the preset voltage and the formed fiber can certainly reach the collection electrode 5; and for example, is preferably in the range of from 10 to 20 cm when the above-mentioned electric potential is approximately 15 kV.

The electrostatic spinning can be performed at a temperature in the range of from 0 to 50° C. depending on easiness for solvent to vaporize and on viscosity of the polymer solution 3, while the electrostatic spinning may be performed at a temperature in the range of 50° C. or higher by heating using, for example, a thermal heater in the case where the solvent is difficult to remove. The temperature of the electrostatic spinning is a temperature of the environment surrounding the electrostatic spinning, including at least the environment where the polymer solution 3 is scattered between the nozzle 4 and the collection electrode 5 in the electrostatic spinning.

The fiber substance 10 obtained by the above-mentioned electrostatic spinning is preferably washed with a solvent at a washing step. The solvent for washing is not particularly limited, and is preferably a solvent which does not affect the liquid crystalline polyester but is capable of washing and removing the fiber-forming polymer away from the fiber substance when necessary. In the case where the fiber-forming polymer exemplified above is utilized, the solvent for washing is preferably water, which may contain an inorganic salt or may have pH adjusted appropriately so as to improve washing efficiency. In the present invention, water tends to remove not only the fiber-forming polymer but also other material (such as by-products) attached to the liquid crystalline polyester fiber.

The fiber substance 10 may further be subjected to a heat treatment depending on the properties of the liquid crystalline polyester fiber desired. The heat treatment occasionally improves mechanical strength of the fiber substance 10 by improving degree of crystallinity of the liquid crystalline polyester fiber and/or causing heat modification of the fiber. In the case where the heat treatment is conducted, the heat treatment is preferably performed at temperature in the range where the fiber-form of the liquid crystalline polyester fiber is maintained.

The fiber substance 10 thus obtained may be used singly as a fiber cloth, or may also be used in combination with another member such as a support depending on easiness of handling and other demand characteristics of the fiber substance. For example, the fiber substance 10 as a fiber cloth may be formed on a support made of another fiber cloth (such as nonwoven cloth and woven cloth), a film or the like, to obtain a laminate thereof. The fiber substance 10 occasionally has a form of not merely a fiber cloth but a tube and a mesh as well.

The fiber substance 10 and the laminated body having the fiber substance 10 can be used, for example, as a base material for a printed wiring board, and may be applied to a wide range of uses of various kinds of filters, catalyst support base materials and battery separator members.

The method for producing a liquid crystalline polyester fiber of the preferred embodiment as described above may be modified if necessary. For example, while the nozzle 4 and the collection electrode 5 as two electrodes are utilized in the preferred embodiment using the electrostatic spinning apparatus 1, three electrodes consisting of two electrodes different in voltage value and an earthed electrode may be utilized, or more electrodes may be utilized in the present invention.

In addition, while in the preferred embodiment the collection electrode 5 serves both as an electrode and a collection substrate, a collection substrate may be separately provided in front of another electrode on the side of the place for the collecting of the fiber on which the fiber substance 10 is formed. In this case, for example, the a collection substrate having a belt shape may be adopted to perform an electrostatic spinning while being moved, so that the fiber substance 10 can be formed continuously. If the above-mentioned support is previously placed as a collection substrate, the fiber substance 10 can be formed on the support, which makes a laminate thereof.

In addition, a nozzle discharging the polymer solution 3 may not necessarily serve as an electrode, and a liquid crystalline polyester fiber can be formed by the electrostatic spinning using an apparatus in which an electrode is disposed at the side of a nozzle so that the polymer solution 3 is charged. The nozzle need not always be one, and a plurality of nozzles may be used, which may effective in increasing a production rate of producing the fiber substance.

As mentioned above, the present invention provides for a method for producing a thin, fine fiber of a liquid crystalline polyester, a fiber obtained therefrom and a liquid crystalline polyester fiber substance (fiber cloth) comprising the liquid crystalline polyester fiber. The liquid crystalline polyester fiber cloth may be thin but has sufficient properties needed when utilized as a substrate for electronic parts, and therefore, can be used as a base material for a printed wiring board mounted on small-sized electronic parts.

The invention being thus described, it will be apparent that the same may be varied in many ways. Such variations are to be regarded as within the spirit and scope of the invention, and all such modifications as would be apparent to one skilled in the art are intended to be within the scope of the following claims.

The entire disclosure of the Japanese Patent Application No. 2007-36775 filed on Feb. 16, 2007, including specification, claims, drawings and summary, are incorporated herein by reference in their entirety.

### EXAMPLES

The present invention is described in more detail by following Examples, which should not be construed as a limitation upon the scope of the present invention.

The average fiber diameter and water absorption rate of the liquid crystalline polyester fiber cloth (a nonwoven cloth; fiber substance) produced in the following Examples and Comparative Examples were measured in accordance with the following methods.

### Average Fiber Diameter:

A scanning electron microscope (SEM) photograph (5000-times magnification) on the surface of the obtained fiber substance (cloth) to be measured was taken. The fiber diameters of twenty fibers chosen with no intention in the photograph were measured, and the average value of the fiber diameters was calculated. The average value was regarded as the average fiber diameter of the fiber substance.

### Water Absorption Rate

The fiber substance (cloth) obtained by electrostatic spinning was peeled off from copper foil as a collection substrate, and the fiber cloth thus obtained was dried at a temperature of 120° C. for 1 hour, and thereafter was preserved in a desiccator through the night. Then, the fiber cloth was maintained for 168 hours under the conditions of 85° C. and 85% RH by using a pressure cooker to conduct a moisture absorption treatment. The water absorption rate of the fiber cloth was calculated based on the change in weight before and after the moisture absorption treatment.

### Synthesis Example 1

A reaction vessel equipped with a stirring apparatus, a torque meter, a nitrogen gas inlet tube, a thermometer and a reflux condenser was charged with 941 g (5.0 mol) of 2-hydroxy-6-naphthoic acid, 507 g (4.6 mol) of 4-aminophenol, 772 g (4.6 mol) of isophthalic acid and 1123 g (11 mol) of acetic anhydride. The inside of the reaction vessel was sufficiently substituted with nitrogen gas, thereafter heated up to a temperature of 150° C. over 15 minutes under nitrogen gas current, and the resulting mixture was refluxed for 3 hours, while maintaining the temperature.

Then, the inside of the reaction vessel was heated up to a temperature of 320° C. over 170 minutes, while distilling off the by-produced acetic acid and unreacted acetic anhydride, which were distilled out. The point of time when the rise of torque was recognized was regarded as reaction completion, to take out the content in the vessel at this point of time. The obtained solid content was cooled to room temperature, crushed by a coarse crusher, which was then maintained at a temperature of 265° C. for 5 hours under nitrogen atmosphere to proceed polymerization reaction in a solid phase. Thus, a liquid crystalline polyester was obtained.

In order to measure the dielectric constant of the liquid crystalline polyester (0.3 g) of the liquid crystalline polyester was subjected to a load of 100 kg by using Flow Tester (‘CFT-500 type’, manufactured by SHIMADZU CORPORATION), pressurized at a temperature of 320° C. for 5 minutes and thereafter cooled to a temperature of 200° C. to produce a tablet of the liquid crystalline polyester. The tablet was dried at a temperature of 100° C. for 1 hour, and thereafter preserved in a desiccator through the night. Then, the dielectric constant of the tablet was measured using an impedance analyzer (manufactured by HP). As a result, the dielectric constant of the liquid crystalline polyester was 3.01 (a measuring frequency of 1 GHz).

### Example 1

Into 180 g of N,N-dimethylacetamide, 20 g of the liquid crystalline polyester obtained in Synthesis Example 1 was added and completely dissolved by heating at a temperature of 140° C. for 4 hours to obtain a brown and transparent solution. Subsequently, 0.5 part by weight of polyethylene glycol (manufactured by Wako Pure Chemical Industries, Ltd.; having an average molecular weight of 500,000) as a fiber-forming polymer was added to and mixed with the solution with respect to 100 parts by weight of the liquid crystalline polyester in the solution. The resulting solution was maintained while mixing at a temperature of 70° C. to produce a polymer solution containing the liquid crystalline polyester and fiber-forming polymer.

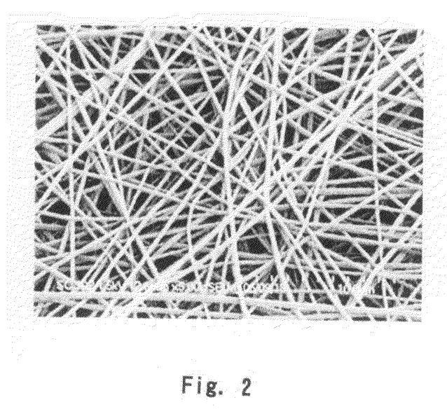

Using the apparatus shown in FIG. 1, an electrostatic spinning was performed by discharging the polymer solution from the nozzle 4 toward the collection electrode 5 for 20 minutes to form a fiber substance on the collection electrode 5. The inside diameter of the nozzle 4 was 0.7 mm, the voltage was 12 kV and the distance from the nozzle 4 to the collection electrode 5 was 12 cm. A scanning electron microscope photograph on the surface of the obtained fiber substance was taken. The photograph is shown in FIG. 2, in which the obtained fiber substance was observed to be a fiber cloth composed of fiber. The average fiber diameter of the fiber in the cloth was 0.58 μm. The water absorption rate of the fiber cloth was 0.90%.

### Example 2

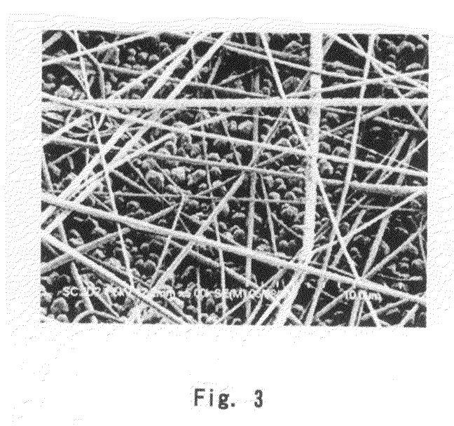

A fiber substance was obtained in the same manner as in Example 1 except that polyethylene glycol (manufactured by Wako Pure Chemical Industries, Ltd.; having an average molecular weight of 2,000,000) as a fiber-forming polymer was used instead of using the polyethylene glycol having an average molecular weight of 500,000. A scanning electron microscope photograph on the surface of the obtained fiber substance was taken. The photograph is shown in FIG. 3, in which the obtained fiber substance was observed to be a fiber cloth composed of fiber. The average fiber diameter of the fiber in the cloth was 0.66 μm. The water absorption rate of the fiber cloth was 0.83%.

### Comparative Example 1

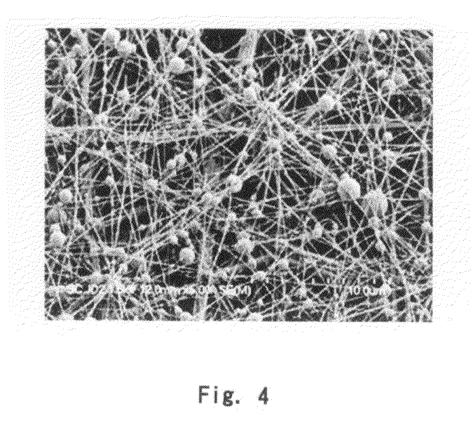

The electrostatic spinning step was conducted in the same manner as in Example 1 except that no polyethylene glycol was used. A material formed on the collection electrode 5 was observed with SEM. As a result, it was found that the material has no structure of fiber, which is shown in A scanning electron microscope photograph on the surface of the material is shown in FIG. 4.

What is claimed is:

1. A method for producing a liquid crystalline polyester fiber, the method comprising the steps of:
discharging an electrically charged solution comprising a liquid crystalline polyester, a fiber-forming polymer and a solvent from a container; and
drawing the charged solution by electrical attraction in an electrical field generated between the solution and an electrically charged collecting means having the opposite charge of the solution, while evaporating at least a portion of the solvent to form a liquid crystalline polyester fiber.

2. The method for producing a liquid crystalline polyester fiber according to claim 1, wherein said solvent is at least one kind of solvent selected from the group consisting of N,N-dimethylacetamide, N,N-dimethylformamide, N-methylpyrrolidone and dimethyl sulfoxide.

3. The method for producing a liquid crystalline polyester fiber according to claim 1, wherein said fiber-forming polymer is a thermoplastic polymer.

4. The method for producing a liquid crystalline polyester fiber according to claim 3, wherein said thermoplastic polymer is at least one kind of polymer selected from the group consisting of polyethylene oxide and polypropylene oxide.

5. The method for producing a liquid crystalline polyester fiber according to claim 1, wherein said liquid crystalline polyester has structural units represented by the following formulae (1), (2) and (3):
—O—Ar¹—CO— (1)
—X—Ar²—Y— (2)
—OC—Ar³—CO— (3)
wherein Ar¹ denotes at least one moiety selected from the group consisting of 1,4-phenylene, 2,6-naphthylene and 4,4′-biphenylene; Ar² denotes at least one moiety selected from the group consisting of 1,4-phenylene, 1,3-phenylene and 4,4′-biphenylene; X and Y denote, each independently, —O— or —NH—; Ar³ denotes at least one moiety selected from the group consisting of 1,4-phenylene, 1,3-phenylene, 2,6-naphthylene and the moiety represented by the formula (4) below:
—Ar⁴¹-Z-Ar⁴²— (4)
wherein Ar⁴¹ and Ar⁴² denote, each independently, at least one moiety selected from the group consisting of 2,6-naphthylene and 4,4′-biphenylene; and Z denotes at least one group selected from the group consisting of groups represented by —O—, —SO₂— and —CO—.

6. The method for producing a liquid crystalline polyester fiber according to claim 1, wherein a molecular weight of said fiber-forming polymer is 200,000 or more.

7. The method for producing a liquid crystalline polyester fiber according to claim 1, wherein the discharging step is carried out under the condition where the temperature of said solution is 60° C. or higher.

8. The method for producing a liquid crystalline polyester fiber according to claim 1, the method further comprising the step of washing said liquid crystalline polyester fiber with a solvent capable of dissolving said fiber-forming polymer after the forming of the fiber.

9. The method for producing a liquid crystalline polyester fiber according to claim 8, wherein said solvent capable of dissolving the fiber-forming polymer is water.

10. A liquid crystalline polyester fiber obtainable by the production method according to claim 1.

11. The liquid crystalline polyester fiber according to claim 10, wherein the liquid crystalline polyester fiber has an average fiber diameter of from 0.01 to 1 μm.

12. The liquid crystalline polyester fiber according to claim 10, wherein said liquid crystalline polyester is soluble in an organic solvent.

13. The liquid crystalline polyester fiber according to claim 10, wherein said liquid crystalline polyester has structural units represented by the following formulae (1), (2) and (3):
—O—Ar¹—CO— (1)
—X—Ar²—Y— (2)
—OC—Ar³—CO— (3)
wherein Ar¹ denotes at least one moiety selected from the group consisting of 1,4-phenylene, 2,6-naphthylene and 4,4′-biphenylene; Ar² denotes at least one moiety selected from the group consisting of 1,4-phenylene, 1,3-phenylene and 4,4′-biphenylene; X and Y denote, each independently, —O— or —NH—; Ar³ denotes at least one moiety selected from the group consisting of 1,4-phenylene, 1,3-phenylene, 2,6-naphthylene and the moiety represented by the formula (4) below:
—Ar⁴¹-Z-Ar⁴²— (4)
wherein Ar⁴¹ and Ar⁴² denote, each independently, at least one moiety selected from the group consisting of 2,6-naphthylene and 4,4′-biphenylene; and Z denotes at least one group selected from the group consisting of groups represented by —O—, —SO₂— and —CO—.

14. A liquid crystalline polyester fiber substance which comprises the liquid crystalline polyester fiber according to claim 10.
